(19) United States
(12) Patent Application Publication
(10) Pub. No.: US 2019/0042061 A1
(43) Pub. Date: Feb. 7, 2019

(54) SYSTEM AND METHOD FOR GENERATING CUSTOMIZED INFORMATION VIEWS

(71) Applicant: I.T. Crisis Services Inc., Woodland Hills, CA (US)

(72) Inventors: Brent H. Woodworth, Calabasas, CA (US); Joseph Bouffiou, Monroe, WA (US); Brian Carlson, Rancho Cucamonga, CA (US)

(21) Appl. No.: 15/669,918

(22) Filed: Aug. 5, 2017

(51) Int. Cl. G06F 3/0482; H04L 29/08; G06F 3/0484

(52) U.S. Cl. CPC G06F 3/0482; G06F 3/04847; H04L 67/36

(57) ABSTRACT

A system and method for generating customized information views is disclosed. A particular embodiment includes: establishing, by use of a data processor and a data network, a network data connection with a plurality of network resources; enabling a user to select from among a set of information category and sub-category options; enabling the user to select from among a set of information components within the user selected information category and sub-category options, the user selected information component having an associated component type, the component type defining an information source and a particular type of functionality and behavior associated with the information component; gathering information from a network resource of the plurality of network resources, the network resource corresponding to the information source defined by the information component type; enabling the user to place the information component on a user interface dashboard at a user-selected location and with a user-selected size; and presenting the information gathered from the network resource within the information component on the dashboard.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016-2017 I.T. Crisis Services, Inc. (ITC), All Rights Reserved.

### TECHNICAL FIELD

This patent application relates to computer-implemented software systems, user interfaces, and systems for disaster management, according to one embodiment, and more specifically to a system and method for generating customized information views.

### BACKGROUND

Work environments are inundated with information, and it can be challenging to filter and separate what is needed from background noise. Databases and network file systems are storing more and more data, and users are often unaware of where to look to find available information. Further, many organizations are confronted with a collection of modern and older legacy information systems that provide content that is duplicative, un-sharable, and sometimes outdated. These systems have been originally designed and deployed to satisfy specific business tasks, without the conception of a larger enterprise business process or the usage of the information by other networked users. Today it is common to see many independent computing systems unable to interconnect with one another. This is especially true of the emergency response and management sectors of society. Furthermore, the ramifications of this problem in this sector are enormous for society as a whole; much more so than the effects of these problems in other areas.

Emergency managers and public safety officials at all levels recognize the current need for seamless, integrated, and timely access to information and services that support the complete lifecycle of disaster management. Emergency management life cycle processes include preparing for emergencies and disasters, responding to them when they occur, helping people and institutions recover from them, mitigating their effects, reducing the risk of loss, and preventing them from occurring.

A solution that fully supports the disaster management lifecycle would focus on and address the requirements of information and service providers, both government and non-government organizations, as well as the recipients, or end users of information and emergency services, which include businesses, organizations, and the public. Thus, it would be desirable to have a method, system, and computer program product that increases information sharing, provides situational awareness and coordination of resources, and provides assets for public safety and emergency management professionals. Such a method, system, and computer program product would enable these professionals to manage their organizations more effectively and enable first responders, emergency managers, state and local public officials, and healthcare providers to get the information they need, when they need it, thereby enabling rapid and effective decision-making which is so crucial during emergency situations.

### SUMMARY

In various example embodiments, a system and method for generating customized information views is disclosed. In the various example embodiments described herein, a computer-implemented tool or software application (app) as part of a customized information view generation system is described to automate customized information view creation using information categories and subcategories, information component libraries, and a drag-and-drop user interface. As described in more detail below, a computer or computing system on which the described embodiments can be implemented can include personal computers (PCs), portable computing devices, laptops, tablet computers (e.g., iPad™), personal digital assistants (PDAs), personal communication devices (e.g., cellular telephones, smartphones, or other wireless devices), network computers, set-top boxes, servers, mainframe computers, wearable computing devices, Internet-of-Things (IoT) devices, or any other type of computing, data processing, communication, networking, or electronic system.

The customized information view generation system of the various example embodiments described herein enables the aggregation of specific sets of information from a variety of sources and the arrangement of the information in a particular user-generated format. The particular arrangement of the information can be shared with others in specified organizations or information sharing groups. The customized arrangement of information enables a quick assessment of current and dynamically changing information, such as situations involving emergencies, disasters, police actions, fire events, terrorism, and the like.

The customized information view generation system of the various embodiments described herein enables users or customers to drag data rich information components from a component library onto their user interface dashboard. The information components can include custom applications that can be added into the component library. Core information components of an example embodiment include, but are not limited to: document libraries, photo galleries, situation reports, external links, script editors, alerts, global alerts, RSS (Really Simple Syndication) aggregators, Twitter™ feeds, YouTube™ content, Instagram™ content, interactive maps, and more. Information views can be dynamically created based on user or customer defined themes, user-defined content selections, and user-defined arrangements of the selected content. Views are comprised of items or information components selected from a Component Library to provide the user with situational awareness through a common operating information set. Information components that reside inside a view are customizable to fit a user's preference in size and location on the user interface dashboard. All information components can be minimized, restored, moved, and removed inside the dashboard. All settings can be saved by the user or customer for future viewing. After a view has been created, the view can be saved for user-only viewing, shared with other members of the organization, or published for all group members.

### BRIEF DESCRIPTION OF THE DRAWINGS

The various embodiments are illustrated by way of example, and not by way of limitation, in the figures of the accompanying drawings in which:

FIG. 1 illustrates an example user interface screen snapshot created by an example embodiment of the customized information view generation system;

FIG. 2 illustrates an ontology of an example embodiment showing the hierarchical relationship between information categories, information sub-categories, and information components;

FIG. 3 illustrates an example embodiment of a networked system in which various embodiments may operate;

FIGS. 4 through 17 illustrate various example user interface screen snapshots that show the basic elements of the user interface for displaying data and receiving user inputs associated with the customized information view generation system in an example embodiment;

FIG. 18 illustrates a sample alert generated by an example embodiment as described herein and presented on a wearable device, such as an iWatch™;

FIG. 19 illustrates another example embodiment of a networked system in which various embodiments may operate;

FIG. 20 illustrates a processing flow diagram that illustrates an example embodiment of a method as described herein; and

FIG. 21 shows a diagrammatic representation of a machine in the example form of a computer system within which a set of instructions when executed may cause the machine to perform any one or more of the methodologies discussed herein; and

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments, a system and method for generating customized information views is disclosed. In the various example embodiments described herein, a computer-implemented tool or software application (app) as part of a customized information view generation system is described to automate customized information view creation using information categories and subcategories, information component libraries, and a drag-and-drop user interface. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, servers, mainframe computers, or any other type of computing, data processing, communication, networking, or electronic system.

The customized information view generation system of the various example embodiments described herein enables the aggregation of specific sets of information from a variety of sources and the arrangement of the information in a particular user-generated format. The particular arrangement of the information can be shared with others in specified organizations. The customized arrangement of information enables a quick assessment of current and dynamically changing information, such as situations involving emergencies, disasters, police actions, fire events, terrorism, and the like.

The customized information view generation system of the various embodiments described herein enables users or customers to drag data rich information components from a component library onto their user interface dashboard. The information components can include custom applications that can be added into the component library. Core information components of an example embodiment include, but are not limited to: document libraries, photo galleries, situation reports, external links, script editors, alerts, global alerts, RSS (Really Simple Syndication) aggregators, Twitter™ feeds, YouTube™ content, Instagram™ content, interactive maps, and more. Information views can be dynamically created based on user or customer defined themes, user-defined content selections, and user-defined arrangements of the selected content. Views are comprised of items or information components selected from a Component Library to provide the user with situational awareness through a common operating information set. Information components that reside inside a view are customizable to fit a user's preference in size and location on the user interface dashboard. All information components can be minimized, restored, moved, and removed inside the dashboard. All settings can be saved by the user or customer for future viewing. After a view has been created, the view can be saved for user-only viewing, shared with other members of the organization, or published for all group members.

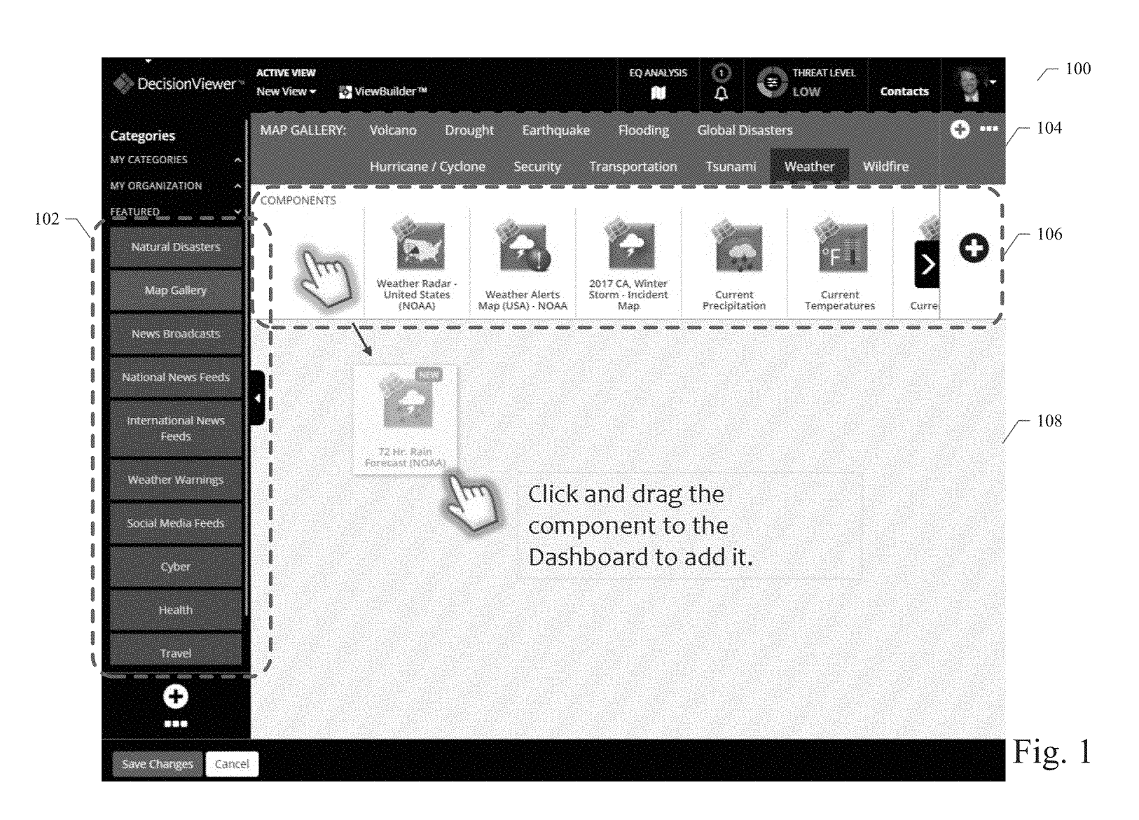

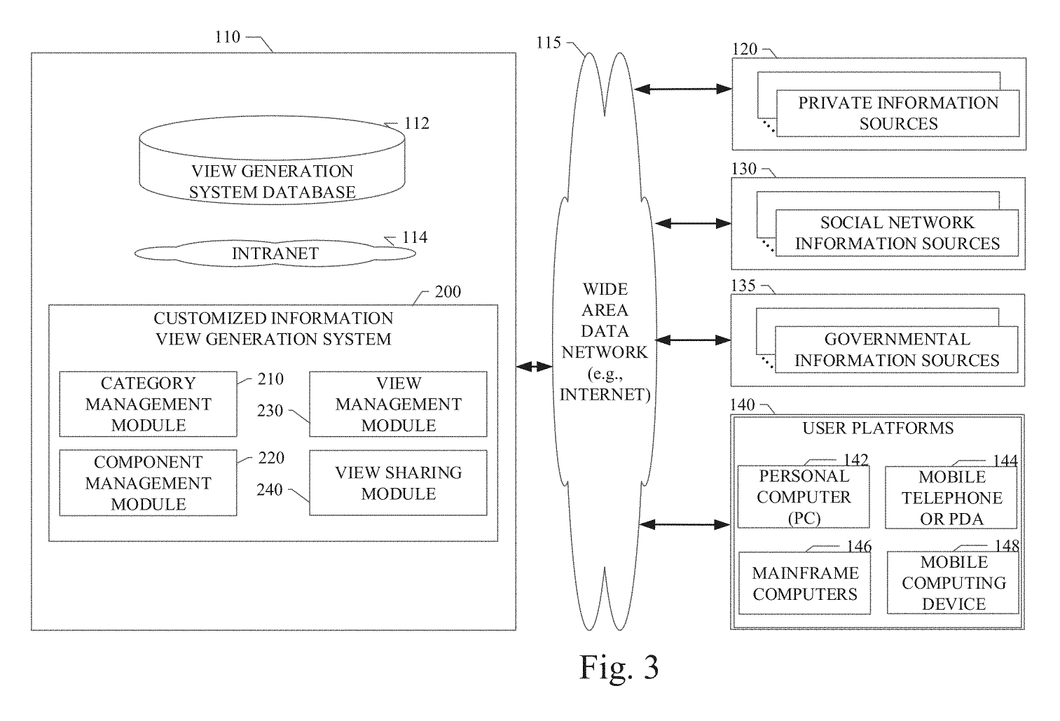

FIG. 1 illustrates an example user interface screen 100 snapshot created by the customized information view generation system implemented as a web application (web app). The left side portion of FIG. 1 illustrates a set of user-selectable information category options 102. The category option set 102 enables a user to view, manipulate, and select from among a variety of information category options presented by the user interface 100 as part of the customized information view generation system. The upper portion of FIG. 1 illustrates a set of user-selectable information sub-category options 104. The sub-category option set 104 enables a user to view, manipulate, and select from among a variety of information sub-category options presented by the user interface 100 as part of the customized information view generation system. The particular sub-category option set 104 presented corresponds to the category option selected from the category option set 102. As shown in the example of FIG. 1, the particular sub-category option set 104 shown is a set of “Map Gallery” sub-options presented as a result of the selection of the “Map Gallery” category option selected from the category option set 102. Another portion of FIG. 1 also illustrates a set of user-selectable information component options 106. The information component option set 106 enables a user to view, manipulate, and select from among a variety of information component options presented by the user interface 100 as part of the customized information view generation system. The particular information component option set 106 presented corresponds to the sub-category option selected from the sub-category option set 104. As shown in the example of FIG. 1, the particular information component option set 106 shown is a set of “Weather” related information component options presented as a result of the selection of the “Weather” sub-category option selected from the sub-category option set 104. Any of the information component options of option set 106 can be selected (e.g., clicked with a cursor control, mouse, or pointing device) and dragged into the user interface dashboard region 108. One or a plurality of the information components can be dragged into the dashboard 108. In this manner, a user-selectable combination of information components can be aggregated into the dashboard 108. As described in more detail below, the information content associated with each of the information sources corresponding to each of the information components can be presented in the dashboard 108 at a location and size corresponding to the user-selected location and size of the information components placed in the dashboard 108 by the user. It will be apparent to those of ordinary skill in the art in view of the disclosure herein that the web app implementation of the example user interface 100 shown in FIG. 1 can be similarly implemented as a mobile application (app) interface or an interface for other interactive devices. The web app and the mobile app of various example embodiments can have a similar software architecture, which is described for an example embodiment in more detail below in connection with FIG. 3.

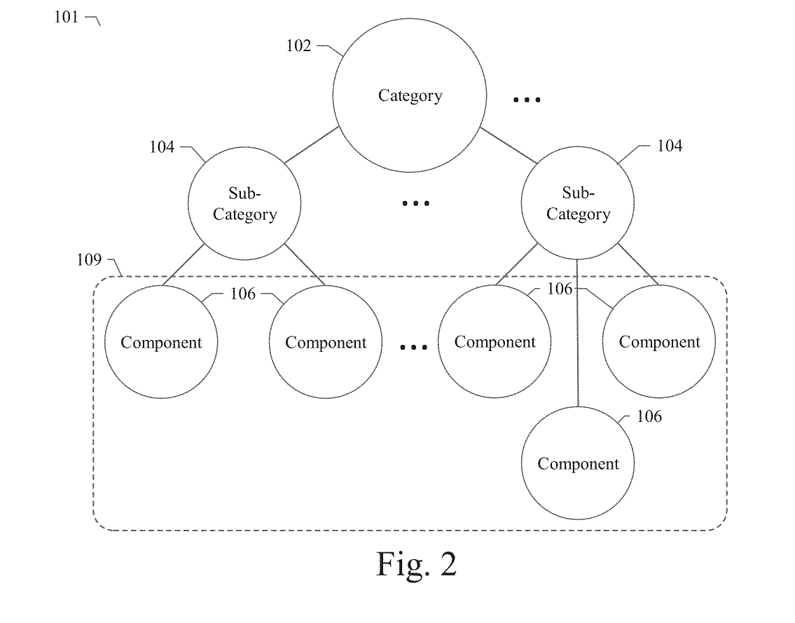

FIG. 2 illustrates an ontology of an example embodiment showing the hierarchical relationship between information categories, information sub-categories, and information components. As shown in FIG. 2, a plurality of information categories 102 can be defined in an example embodiment. The definition of information categories 102 can be pre-determined or automatically indexed using conventional techniques. Each of the plurality of information categories 102 can have an associated plurality of information sub-categories 104. Again, the definition of information sub-categories 104 can be pre-determined or automatically indexed using conventional techniques. Each of the plurality of information sub-categories 104 can have an associated plurality of information components 106. As described in more detail below, the information components 106 can be created and maintained in an information component library 109 from which users can make selections for customizing a particular information view.

FIG. 3, in an example embodiment, illustrates a system for enabling customized information view creation. In various example embodiments, an application or service, typically provided by or operating on a host site (e.g., a website) 110, is provided to simplify and facilitate the downloading or hosted use of the customized information view generation system 200 of an example embodiment. In a particular embodiment, the customized information view generation system 200 can be downloaded from the host site 110 by a user at a user platform 140. Alternatively, the customized information view generation system 200 can be hosted by the host site 110 for a networked user at a user platform 140. The details of the customized information view generation system 200 for an example embodiment are provided below.

Referring again to FIG. 3, the customized information view generation system 200 can be in network data communication with a plurality of private information sources 120, a plurality of social network information sources 130, and/or a plurality of governmental information sources 135. The private information sources 120 can include websites, private information sources, scientific information sources, administrative information sources, charitable or foundation information sources, academic or educational sources, international sites, or other network resources at which information regarding various categories or sub-categories of information is available. In a particular embodiment, one or more of the private information sources 120 can correspond to one or more of the information components 106 of the information component library 109. The customized information view generation system 200 can be configured to obtain the information content available from the private information sources 120 in a digital or computer-readable form via the network 115. The customized information view generation system 200 can also be in network data communication with a plurality of social network information sources 130. The social network information sources 130 can include websites, social media sites, conventional social networking sites (e.g., Twitter™, YouTube™, Instagram™, FaceBook™, etc.), digital message boards, chat rooms, or other network resources at which information regarding the various categories or sub-categories of information is available. In a particular embodiment, one or more of the social network information sources 130 can correspond to one or more of the information components 106 of the information component library 109. The customized information view generation system 200 can be configured to obtain the information content available from the social network information sources 130 in a digital or computer-readable form via the network 115. The customized information view generation system 200 can also be in network data communication with a plurality of governmental information sources 135. The plurality of governmental information sources 135 can include websites, government agency sites, legislative sites, judicial sites, law enforcement sites, military sites, emergency management sites, or other network resources at which information regarding the various categories or sub-categories of information is available. In a particular embodiment, one or more of the plurality of governmental information sources 135 can correspond to one or more of the information components 106 of the information component library 109. The customized information view generation system 200 can be configured to obtain the information content available from the plurality of governmental information sources 135 in a digital or computer-readable form via the network 115.

One or more of the plurality of private information sources 120, the plurality of social network information sources 130, and/or the plurality of governmental information sources 135 can be provided by one or more third party providers operating at various locations in a network ecosystem. It will be apparent to those of ordinary skill in the art that the plurality of private information sources 120, the plurality of social network information sources 130, and the plurality of governmental information sources 135 can be any of a variety of networked third party information providers, websites, network-accessible information nodes, or other network resources as described in more detail below. In a particular embodiment, a resource list maintained at the host site 110 can be used as a registry or list of all private information sources 120, social network information sources 130, and governmental information sources 135, which users or the host site 110 may visit/access and from which users or the host site 110 can obtain information content. The host site 110, private information sources 120, social network information sources 130, or governmental information sources 135, and user platforms 140 may communicate and transfer data and information in the data network ecosystem shown in FIG. 3 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 115 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 115 and 114 may also include an autonomous system of terminals, gateways, routers, and the like connected by wireless radio links or wireless transceivers. These connectors may be configured to move freely and randomly and organize themselves arbitrarily, such that the topology of networks 115 and 114 may change rapidly and arbitrarily.

Networks 115 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 115 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 115 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 115 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The private information sources 120, social network information sources 130, and/or the governmental information sources 135 may include any of a variety of providers of network transportable digital data. The network transportable digital data can be transported in any of a family of file formats and associated mechanisms usable to enable a host site 110 and a user platform 140 to receive information from or transfer information to a private information source 120, a social network information source 130, and/or a governmental information source 135 over the network 115. In one embodiment, the file format can be a HyperText Markup Language (HTML) format, a WordPress™ format, a Microsoft™ Word text format, a Microsoft™ Excel spreadsheet format, a CSV (Comma Separated Values) format, or the like; however, the various embodiments are not so limited, and other file formats and transport protocols may be used. For example, data formats other than Excel or CSV or formats other than open/standard formats can be supported by various embodiments. Any electronic file format, such as Microsoft™ Access Database Format (MDB), Portable Document Format (PDF), audio (e.g., Motion Picture Experts Group Audio Layer 3—MP3, and the like), video (e.g., MP4, and the like), and any proprietary interchange format defined by specific sites can be supported by the various embodiments described herein. Moreover, private information sources 120, social network information sources 130, and/or the governmental information sources 135 may provide a variety of different data sets.

In a particular embodiment, a user platform 140 with one or more client devices enables a user to access data provided by the customized information view generation system 200 via the host 110 and network 115. Client devices of user platform 140 may include virtually any computing device that is configured to send and receive information over a network, such as network 115. Such client devices may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as servers or mainframe computers 146 and/or mobile computing devices 148, which are known to those of ordinary skill in the art. As such, the client devices of user platform 140 may range widely in terms of capabilities and features. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 140 may also include at least one client application that is configured to receive information content and/or control data from another computing device via a wired or wireless network transmission. The client application may include a capability to provide and receive textual data, graphical data, video data, audio data, and the like. Moreover, client devices of user platform 140 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 3, the customized information view generation system 200 for an example embodiment is shown to include a customized information view generation system database 112. The database 112 can be used to retain a variety of information data sets including, but not limited to, network resource information, user information, user category, sub-category, and information component selections, information view configurations, information view templates, user dashboard configuration information, and the like. It will be apparent to those of ordinary skill in the art that the customized information view generation system database 112 can be locally resident at the host site 110 or remotely located at other server locations or stored in network cloud storage.

Referring again to FIG. 3, host site 110 of an example embodiment is shown to include the customized information view generation system 200. In an example embodiment, customized information view generation system 200 can include a category management module 210, a component management module 220, a view management module 230, and a view sharing module 240. Each of these modules can be implemented as software components executing within an executable environment of the customized information view generation system 200 operating on host site 110 or user platform 140. Each of these modules of an example embodiment is described in more detail below in connection with the figures provided herein.

Referring still to FIG. 3, the customized information view generation system 200 can include a category management module 210. The category management module 210 can be configured to perform the processing as described herein. Initially, the category management module 210 can be configured to establish, by use of a data processor and the data network 115, a network data connection with at least one of the plurality of private information sources 120, the plurality of social network information sources 130, and/or the plurality of governmental information sources 135. Additionally, the category management module 210 can be configured to identify at least one network resource corresponding to each of the information categories of the pre-defined set of information categories 102. The category management module 210 can be configured to generate and display in region 102 on the user interface 100 a user-selectable object or icon associated with each of the available information categories of the pre-defined set of information categories 102.

The category management module 210 can be further configured to identify at least one network resource corresponding to each of the information sub-categories of the pre-defined set of information sub-categories 104. The category management module 210 can be configured to generate and display in region 104 on the user interface 100 a user-selectable object or icon associated with each of the available information sub-categories of the pre-defined set of information sub-categories 104.

Referring still to FIG. 3, the customized information view generation system 200 can include a component management module 220. The component management module 220 can be configured to perform the processing as described herein. The component management module 220 can be configured to establish, by use of a data processor and the data network 115, a network data connection with at least one of the plurality of private information sources 120, the plurality of social network information sources 130, and/or the plurality of governmental information sources 135. Additionally, the component management module 220 can be configured to identify at least one network resource corresponding to each of the information components 106 of the set of information components in the information component library 109. The component management module 220 can also be configured to conform the content of the information component library 109 to the network resources and the information thereon found via the network 115. The component management module 220 can be further configured to generate and display in region 106 on the user interface 100 a user-selectable object or icon associated with each of the available information components of the set of information components in component library 109.

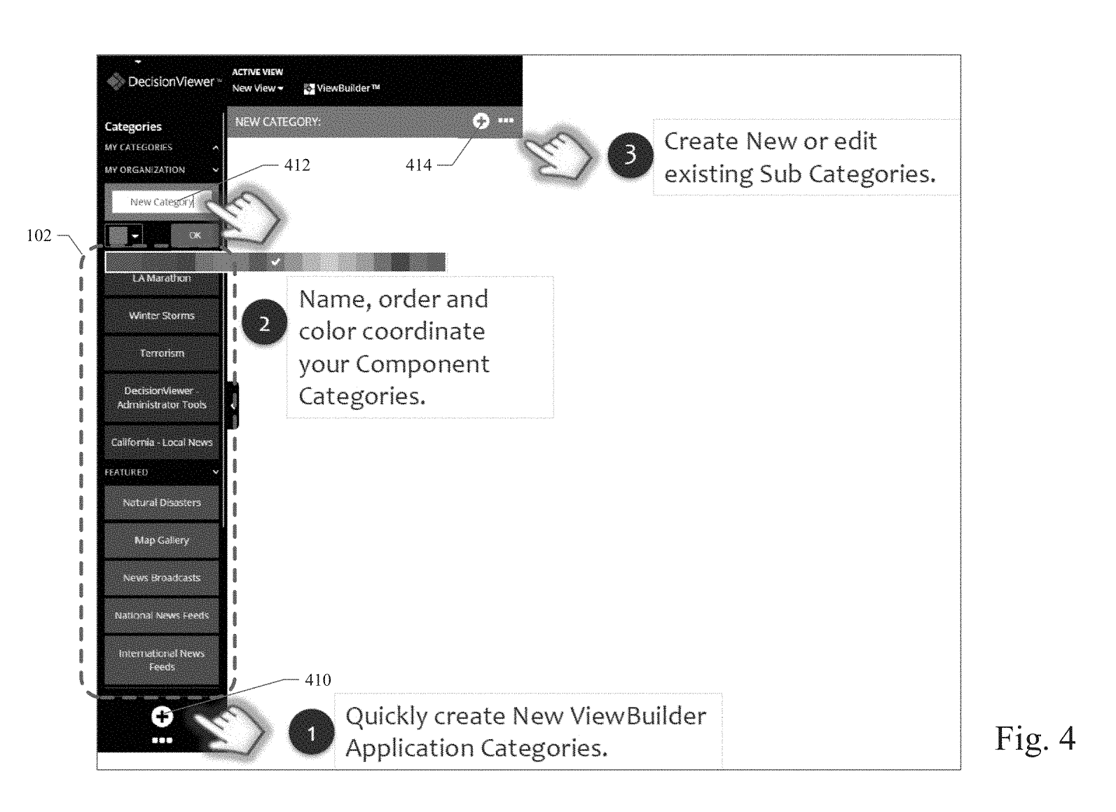

Referring still to FIG. 3, the customized information view generation system 200 can include a view management module 230. The view management module 230 can be configured to perform the processing as described herein. In particular, the view management module 230 can be configured to programmatically enable a user to move information components 106 onto the user interface dashboard 108 in a customized manner. The information components 106 can be moved using a drag and drop process. The information components 106 can be moved to any desired location on the dashboard 108. The information components 106 can also be resized to any desired size on the dashboard 108. Further details of the processing performed by the view management module 230 of an example embodiment are presented below in connection with the sample user interface screen snapshots of FIGS. 4 through 17.

Referring still to FIG. 3, the customized information view generation system 200 can include a view sharing module 240. The view sharing module 240 can be configured to perform the processing as described herein. In particular, the view sharing module 240 can be configured to programmatically enable a user to share a particular customized dashboard view with other users via the network 115. The particular arrangement of information components 106 in the customized view is preserved for the sharing users. The users for whom sharing is enabled can be users in a specified organization or users of a specified information sharing group. Further details of the processing performed by the view sharing module 240 of an example embodiment are presented below in connection with the sample user interface screen snapshots of FIGS. 4 through 17.

As configured and directed by the user via a computer-generated user interface as described herein, the example embodiments described herein can automatically: 1) present and enable selection of a plurality of information categories; 2) present and enable selection of a plurality of information sub-categories within a category selection; 3) present and enable selection of a plurality of information components within a sub-category selection; 4) enable the moving and resizing of a plurality of information components within a user interface dashboard, 5) enable the sharing of a customized user interface dashboard view, and 6) manage a variety of other operations related to the generation, configuration, and execution of a system and method for generating customized information views. In various example embodiments, the computer-generated user interface can be illustrated in several screen snapshots as illustrated herein and described below.

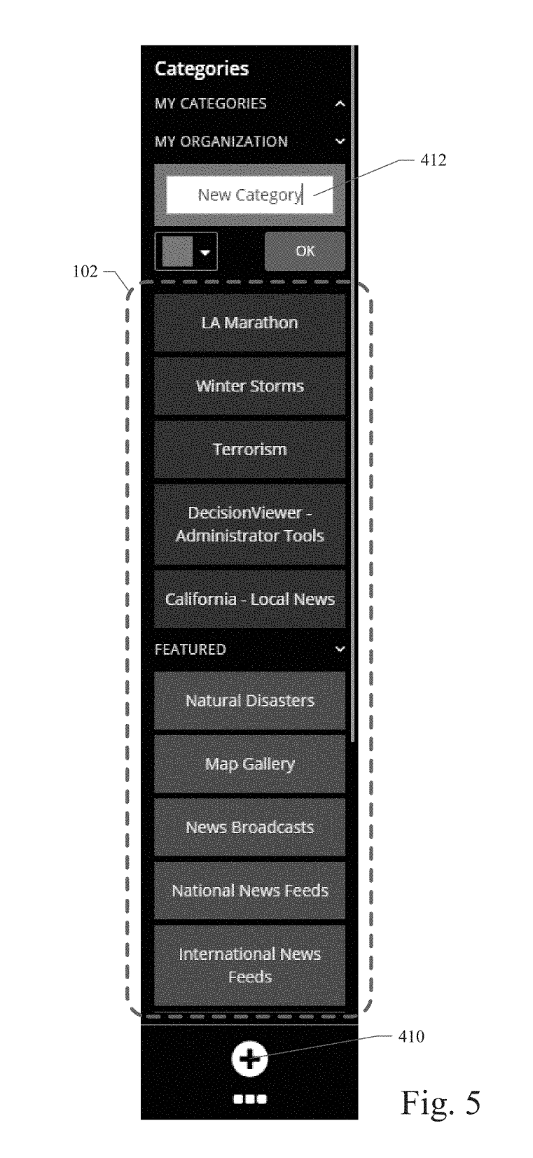

FIGS. 4 through 17 illustrate various example user interface screen snapshots, implemented as a web application, that show the basic elements of the user interface for displaying data and receiving user inputs associated with the customized information view generation system 200 in an example embodiment. Referring to FIGS. 4 and 5, a sample user interface of an example embodiment is shown. Under the direction of the customized information view generation system 200 of an example embodiment, a user can create and edit new information categories 102 by interacting with the input object 410 as shown in FIG. 4. A larger view of the sample user interface is shown in FIG. 5. The new category can be named using the input object 412. Other input objects provided in the user interface can be used to edit a category, specify an ordering, and specify coloration of the categories in the set of categories 102. Similarly, under the direction of the customized information view generation system 200 of an example embodiment, a user can create and edit new information sub-categories 104 by interacting with the input object 414 as shown in FIG. 4. Other input objects provided in the user interface can be used to name the sub-category, edit the sub-category, specify an ordering, and specify coloration of the sub-categories in the set of sub-categories 104.

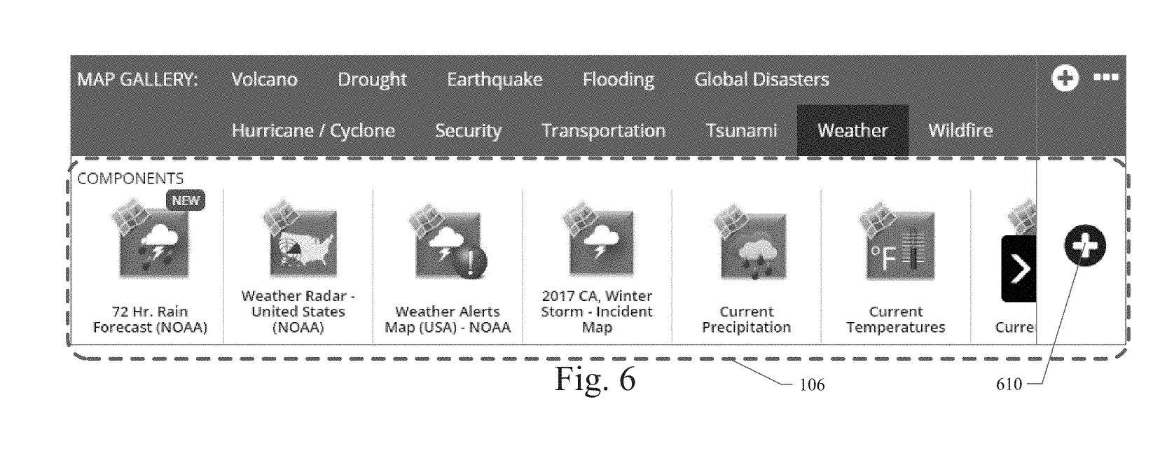

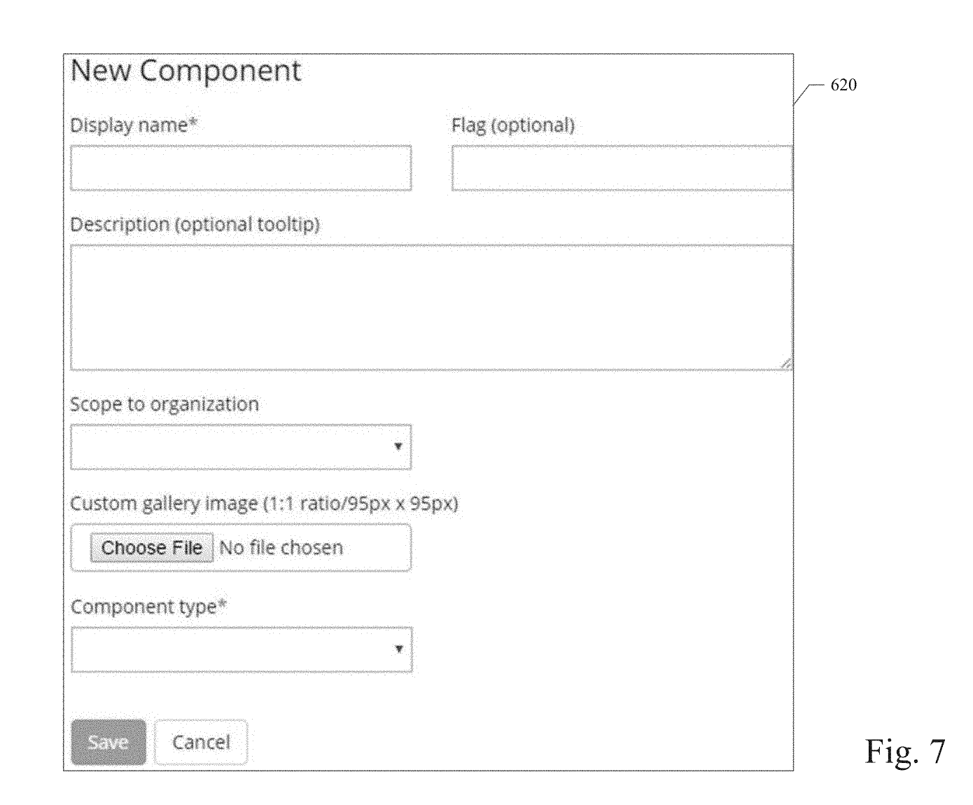

Referring to FIGS. 6 through 14, a sample user interface of an example embodiment is shown. Under the direction of the customized information view generation system 200 of an example embodiment, a user can create and edit new information components 106 by interacting with the input object 610 as shown in FIG. 6. As described above, the information components 106 available for selection can be maintained in the information component library 109. Any of the available information components 106 can be selected and dragged into the dashboard 108. Additionally, new information components 106 can be added to the information component library 109 by use of the input object 610. Upon activation of the input object 610, the display prompt or pop-up window 620 is displayed as shown in FIG. 7.

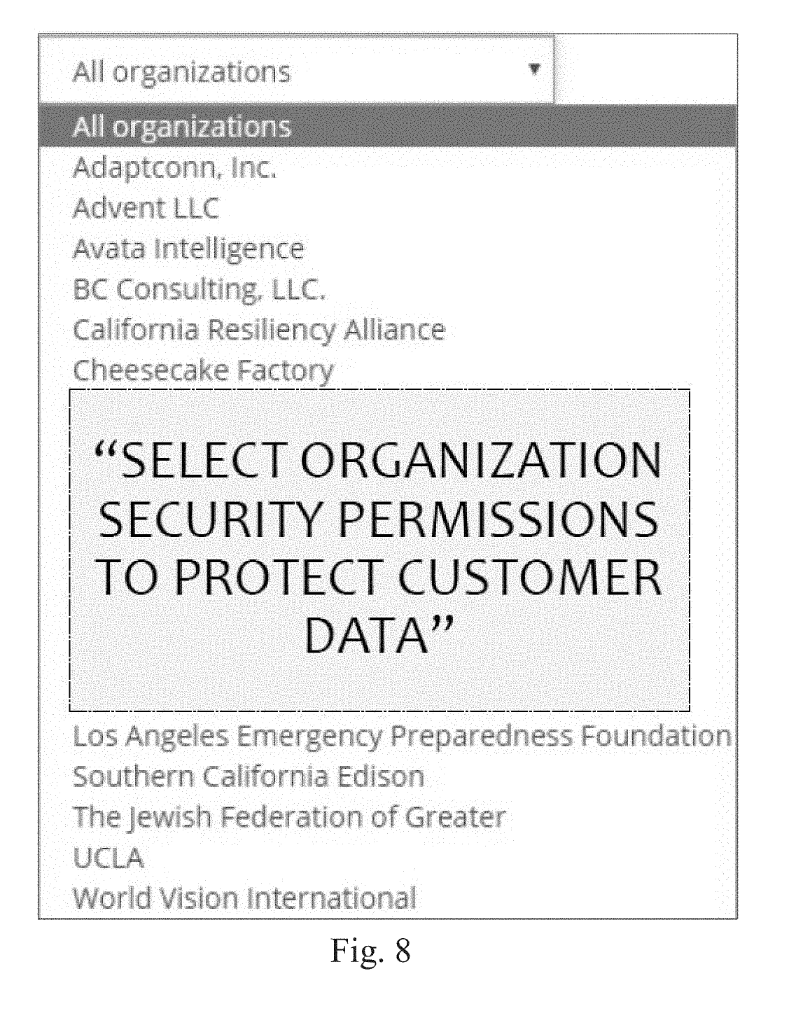

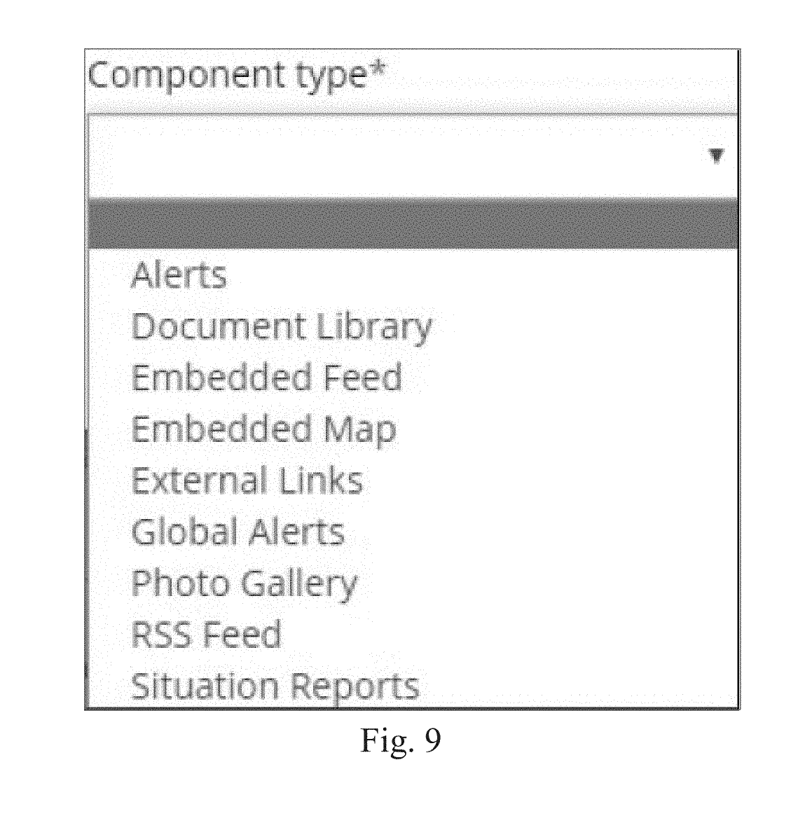

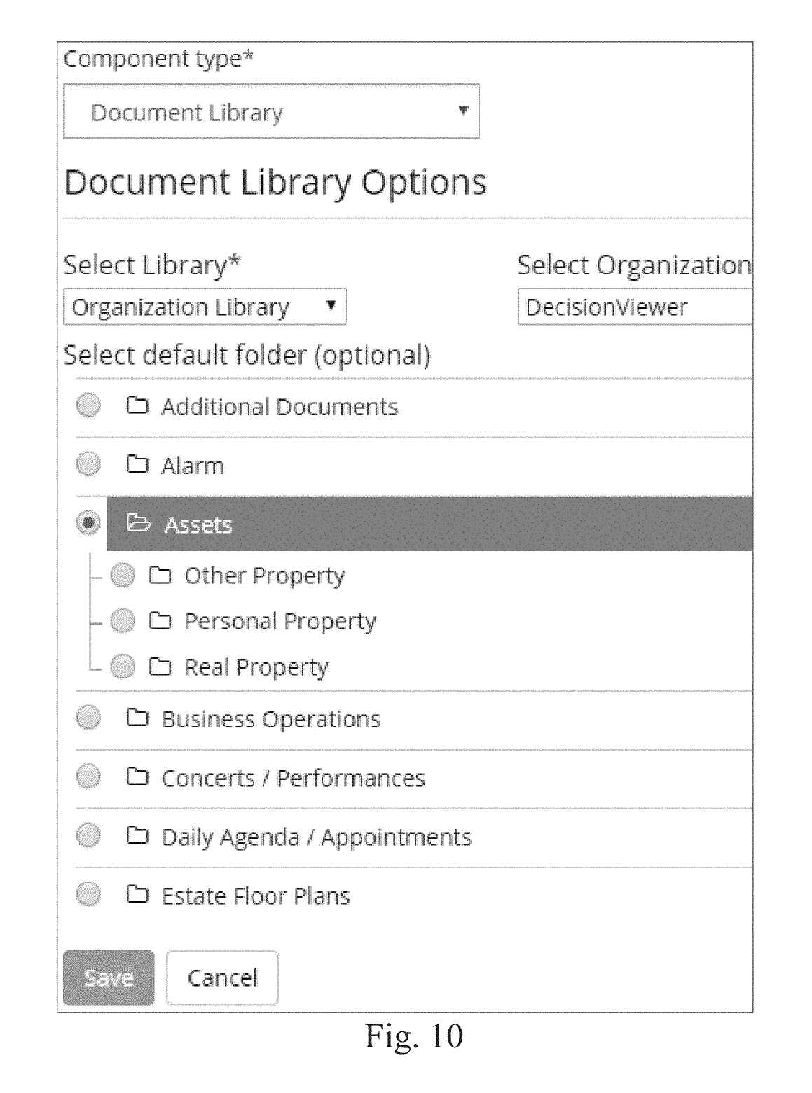

Referring to FIG. 7, a sample user interface of an example embodiment for creating a new information component is shown. The user can use the input fields provided in the prompt 620 to specify a name, a flag, and a narrative description for the new information component. Additionally, the user can assign a scope for the new information object, which can be used to associate the information object with a particular organization or information sharing group. A sample set of scope assignment options is shown in FIG. 8. The scope assignment enables the information object to be shared among members of the specified organization or information sharing group. Referring again to FIG. 7, the user can also use an input field provided in the prompt 620 to specify path to an image to be displayed for the new information component. The user can also use the input fields provided in the prompt 620 to specify a type for the new information component. In an example embodiment, information components can be of several types including: alerts, a document library, an embedded feed, an embedded map, an external link, a global alert, a photo gallery, an RSS feed, and a situation report. The various information component type options for an example embodiment are shown in FIG. 9. The information component type enables the user to associate particular information sources and particular types of functionality and behaviors with particular information components. The various information component types in an example embodiment are described in more detail below and in connection with FIGS. 10 through 14.

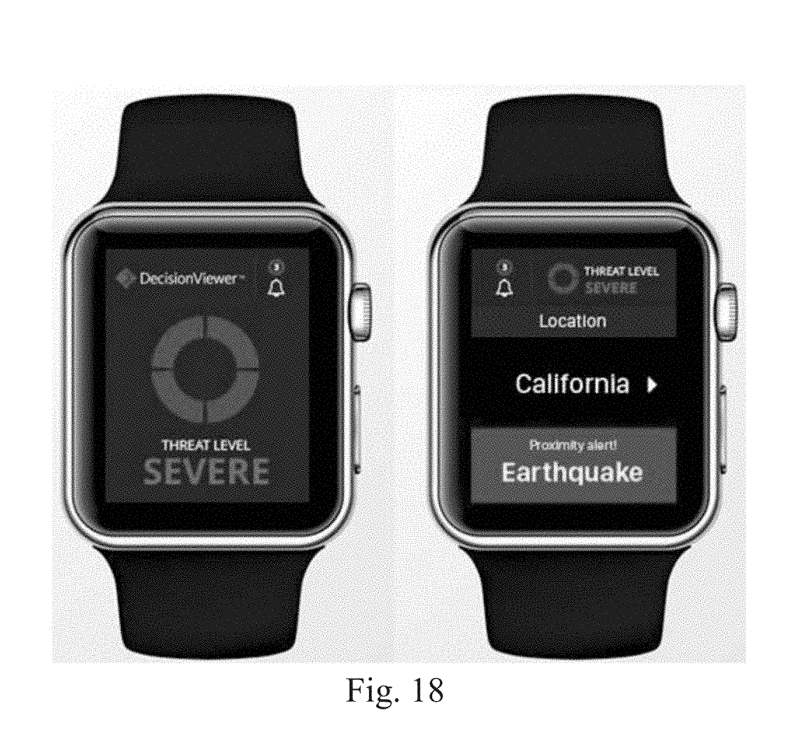

As shown in FIG. 9 for an example embodiment, a user can select a particular information component type from a drop-down list. If the user chooses an alert information component type, the new information component will be configured to issue an alert to a specified group of users when a specified set of conditions is encountered. For example, FIG. 18 illustrates a sample alert generated by an example embodiment as described herein and presented on a wearable device, such as an iWatch™. As such, the customized information view generation system of the various example embodiments described herein enables the presentation of a user interface, customized information, and alerts on a variety of different types of user/client devices.

As shown in FIG. 9, if the user chooses a document library information component type, the new information component will be configured as a document library. FIG. 10 illustrates the prompts provided to the user if the document library component type is selected. The document library component type enables the user to specify the default library, folder, and sub-folders that will be displayed in the new component. All other folders are hidden. The library and folders can serve as the information source for the information component. The user is also prompted to select the organization for which this information component has been created. The document library component type enables the user to associate a set of documents with the new information component.

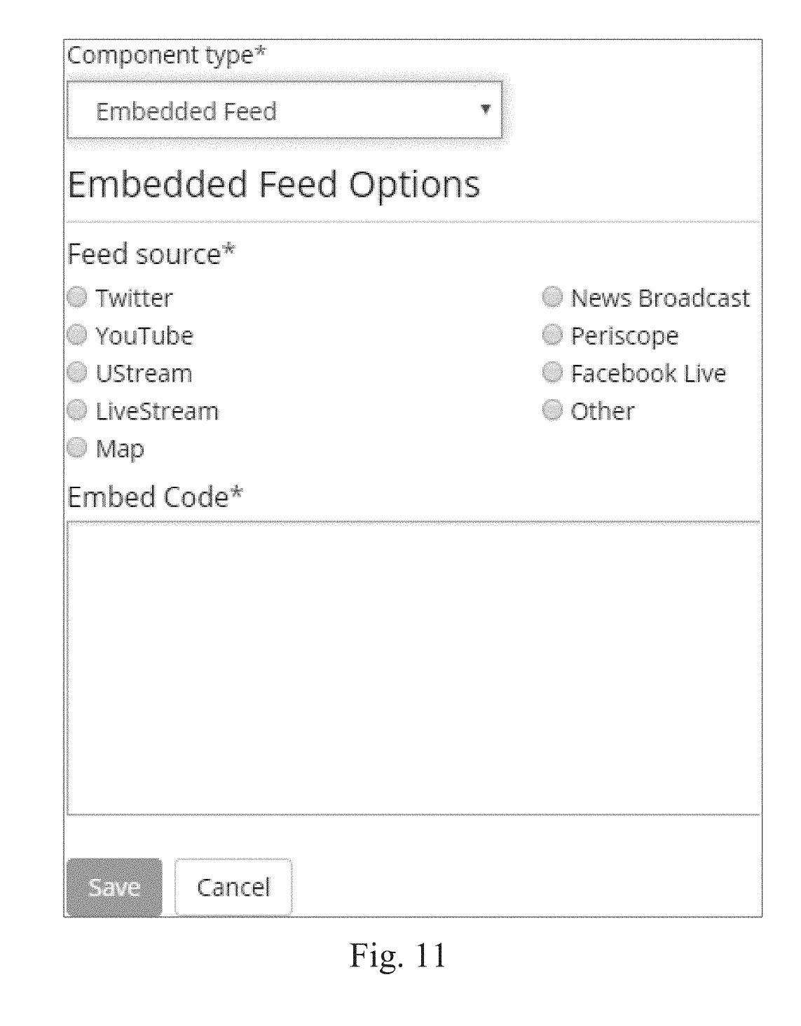

As shown in FIG. 9, if the user chooses an embedded feed or embedded map information component type, the new information component will be configured as an embedded feed or embedded map. FIG. 11 illustrates the prompts provided to the user if the embedded feed or embedded map component type is selected. The embedded feed or embedded map component type enables the user to specify the content feed sources that will be used for the new information component. The embedded feed or embedded map component type also enables the user to insert embedded code that will be executed when the information component is used. The embedded feed or embedded map component type enables the user to aggregate content from various sources with custom code, wherein the aggregated content is associated with the new information component.

As shown in FIG. 9, if the user chooses an external link information component type, the new information component will be configured as an external link. The external link information component can be configured to obtain content from or using the specified external link when the information content is used. For example, a Uniform Resource Locator (URL) or other form of external link can be configured as an external link information component type.

As shown in FIG. 9, if the user chooses a global alert information component type, the new information component will be configured as a global alert. The global alert information component can be configured to issue an alert to all users when a specified set of conditions is encountered.

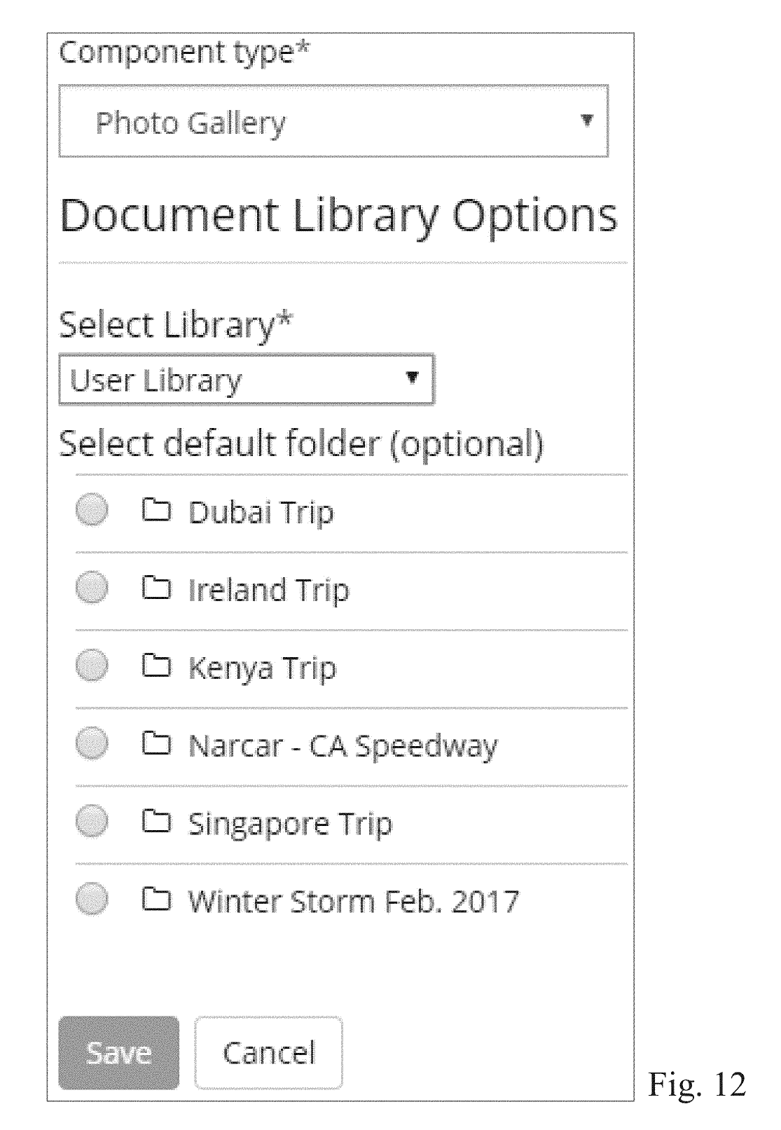

As shown in FIG. 9, if the user chooses a photo gallery information component type, the new information component will be configured as a photo gallery. FIG. 12 illustrates the prompts provided to the user if the photo gallery component type is selected. The photo gallery component type enables the user to specify the default library, folder, and sub-folders that will be displayed in the new component. All other folders are hidden. The library and folders can serve as the information source for the information component. The photo gallery component type enables the user to associate a set of images with the new information component.

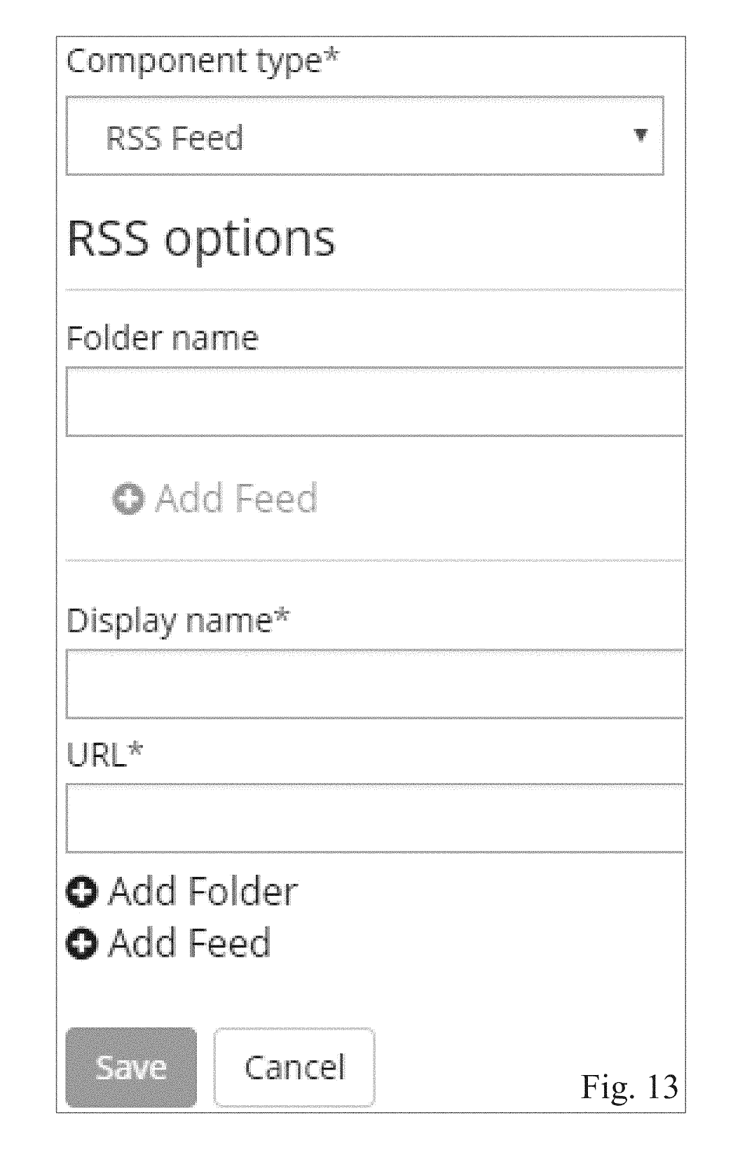

As shown in FIG. 9, if the user chooses an RSS feed information component type, the new information component will be configured as an RSS feed. FIG. 13 illustrates the prompts provided to the user if the RSS feed component type is selected. The RSS feed component type enables the user to specify the default folder, name, and URL that will be used with the new RSS feed component. The RSS feed component type enables the user to associate RSS feeds with the new information component.

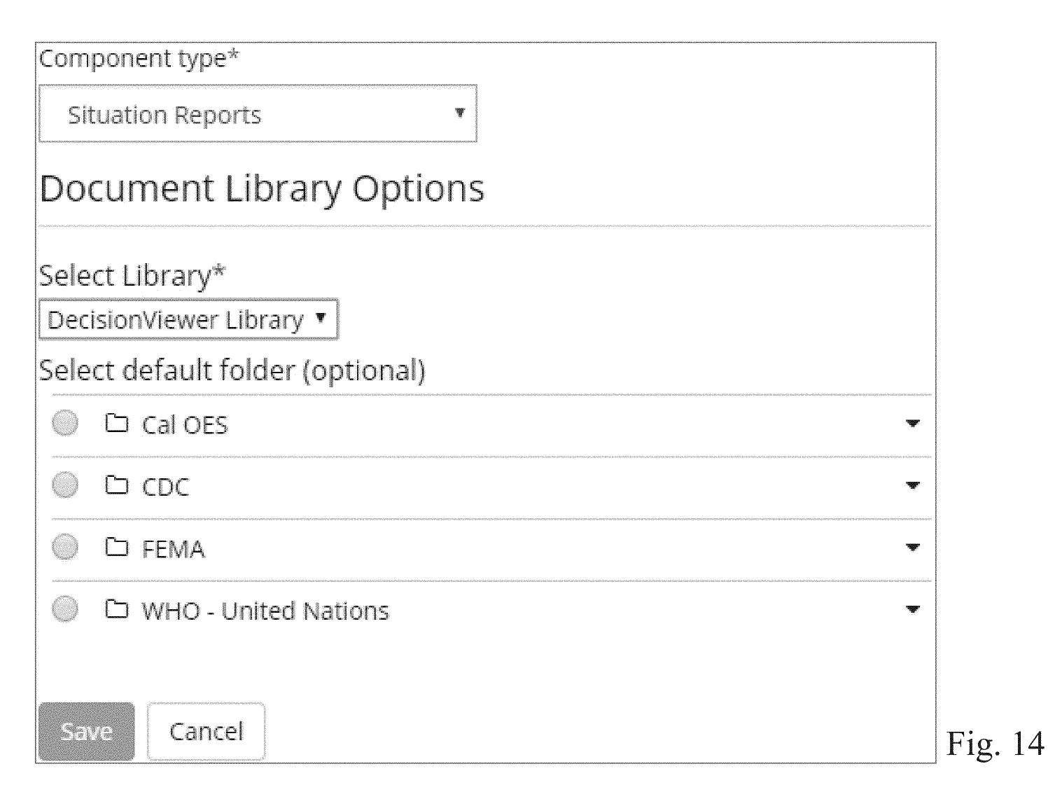

As shown in FIG. 9, if the user chooses a situation report information component type, the new information component will be configured as a situation report. FIG. 14 illustrates the prompts provided to the user if the situation report component type is selected. The situation report component type enables the user to create a list of all available categories or select the default folder and sub-folders that will be displayed in the new component. All other folders are hidden. The folders can serve as the information source for the information component. The situation report enables the user to assemble a set of information and documents from various sources that informs the user of the status or condition of a specified situation.

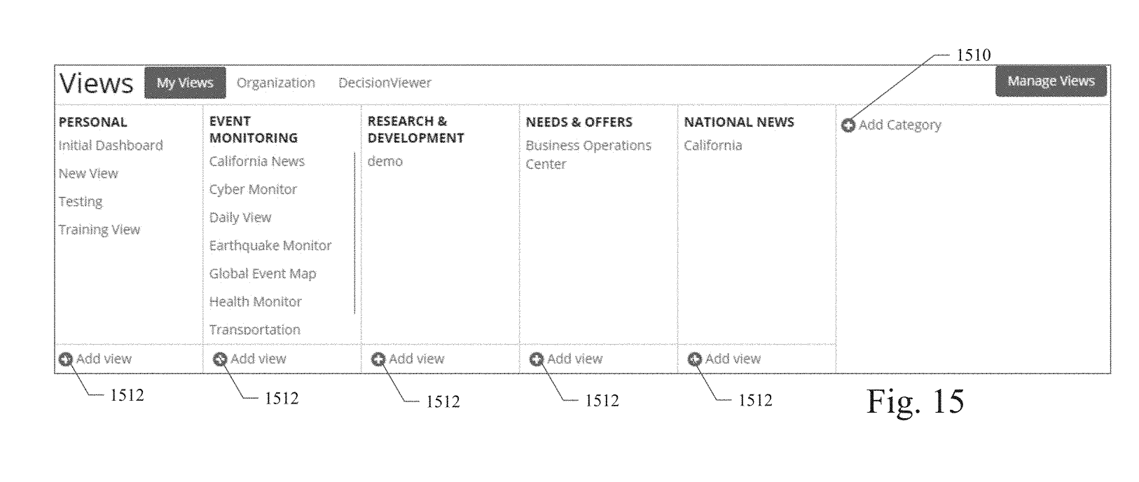

Referring now to FIGS. 15 through 17, sample user interface screen snapshots illustrate the information view management features on an example embodiment. As described above, the view management module 230 can be configured programmatically enable a user to move information components 106 onto the user interface dashboard 108 in a customized manner. The information components 106 can be moved using a drag and drop process. The information components 106 can be moved to any desired location on the dashboard 108. The information components 106 can also be resized to any desired size on the dashboard 108. Further details of the processing performed by the view management module 230 of an example embodiment are presented below in connection with the sample user interface screen snapshots.

Referring now to FIG. 15, a sample user interface screen snapshot illustrates an example embodiment for creating and managing information views. The sample screenshot shows a sample set of view categories configured for a particular user. For example, an “Event Monitoring” view category is shown with a set of associated views “California News”, “Cyber Monitor”, “Daily View”, and so on. Each view in the category represents a user-configured set of information components 106 arranged in a particular customized arrangement, location, and size on a user's dashboard 108. The user can select (e.g., click on) any of the views shown in any of the view categories to open the view. Additionally, the user can add a new view category by interaction with the input object 1510. The user can also add a new view within a particular view category by interaction with any of the input objects 1512.

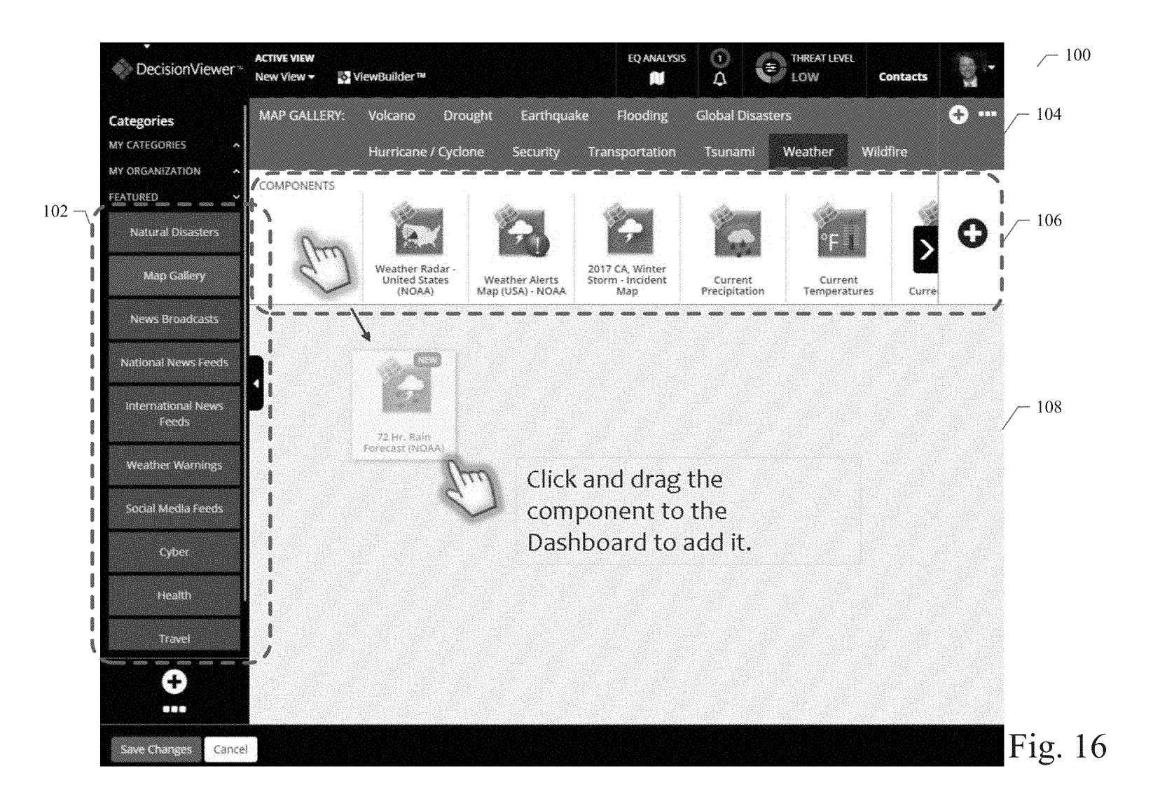

FIG. 16 illustrates an example user interface screen 100 snapshot of the customized information view generation system. As described above, FIG. 1 illustrates a set of user-selectable information category options 102. The category option set 102 enables a user to view, manipulate, and select from among a variety of information category options presented by the user interface 100 as part of the customized information view generation system. FIG. 1 also illustrates a set of user-selectable information sub-category options 104. The sub-category option set 104 enables a user to view, manipulate, and select from among a variety of information sub-category options presented by the user interface 100 as part of the customized information view generation system. The particular sub-category option set 104 presented corresponds to the category option selected from the category option set 102. FIG. 1 also illustrates a set of user-selectable information component options 106. The information component option set 106 enables a user to view, manipulate, and select from among a variety of information component options presented by the user interface 100 as part of the customized information view generation system. The particular information component option set 106 presented corresponds to the sub-category option selected from the sub-category option set 104. Any of the information component options of option set 106 can be selected (e.g., clicked with a cursor control, mouse, or pointing device) and dragged into the user interface dashboard region 108. One or a plurality of the information components can be dragged into the dashboard 108. In this manner, a user-selectable combination of information components can be aggregated into the dashboard 108. As a result, the information content from each of the information sources corresponding to each of the information components can be presented in the dashboard 108 in an information view at a location and size corresponding to the user-selected location and size of the information components placed in the dashboard 108 by the user.

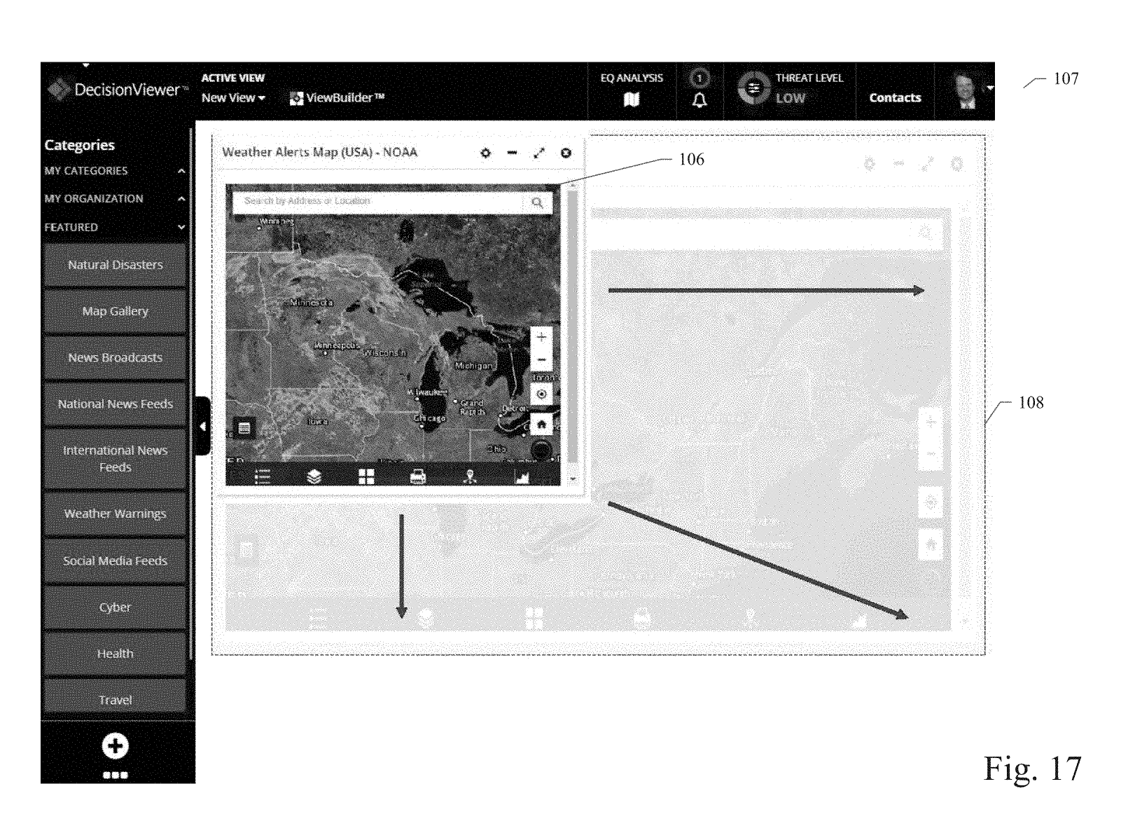

FIG. 17 illustrates another example user interface screen 107 snapshot of the customized information view generation system. In this example, a particular information component 106, selected by the user, has been moved into the dashboard 108. Once on the dashboard 108, the edges of the information component 106 can be selected and dragged to resize the information component 106 in a horizontal and/or vertical direction as indicated by the arrows shown in FIG. 17. Additionally, the information component 106 can be selected and moved to any location on the dashboard 108. As a result, a user selected information component 106 can be placed on the dashboard 108 in any user-selected location on the dashboard 108 and resized to any user-selected size. Similarly, a plurality of information components 106 can be arbitrarily placed, located, and resized on the dashboard 108 to create a customized information view. The information view created by the user can be saved as a new view and restored in a subsequent user session. The example embodiment also provides a set of templates from which the user can select a pre-defined view. The template views can be further customized by the user. Moreover, the template views and the customized views created by a particular user can be shared among other users of a specified organization or information sharing group, shared among a global community, or shared among all users. Further, the example embodiments described herein enable legacy intranet sites and portals to be iframed within a custom component and added to a view to consolidate information. As well known to those of ordinary skill in the art, an iframe is the use of an HTML document that is embedded inside another document, such as a document on a website. In other words, an iframe can be used to insert a portion of content from another source into a webpage. The example embodiments described herein enable the use of iframing to further customize the presentation of information to a user.

It will be apparent to those of ordinary skill in the art in view of the disclosure herein that the web app implementation of the example user interfaces shown in FIGS. 4 through 17 can be similarly implemented as a mobile application (app) interface or an interface for other interactive devices. The web app and the mobile app of various example embodiments can have a similar software architecture, which is described for various example embodiments herein.

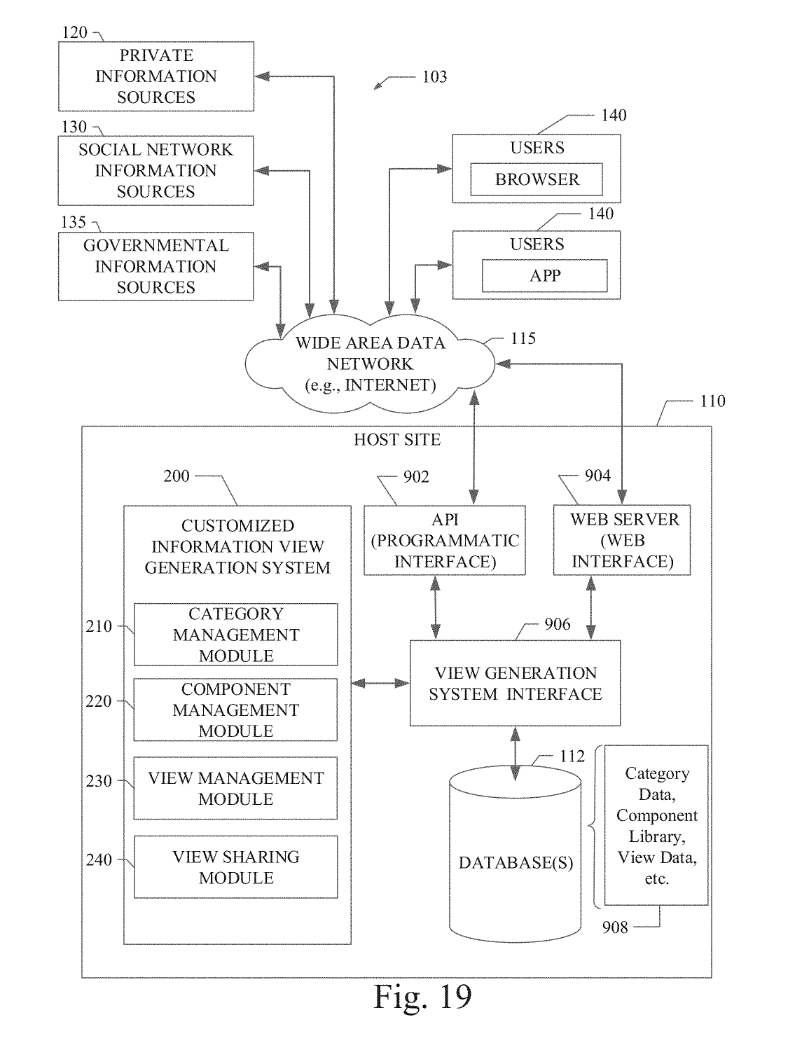

Referring now to FIG. 19, another example embodiment 103 of a networked system in which various embodiments may operate is illustrated. In the embodiment illustrated, the host site 110 is shown to include the customized information view generation system 200. The customized information view generation system 200 is shown to include the functional components 210 through 240, as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities or resources on a programmatic or automated data transfer level. The API 902 and web interface 904 may be configured to interact with the customized information view generation system 200 either directly or via an interface 906. The customized information view generation system 200 may be configured to access a data storage device 112 either directly or via the interface 906.

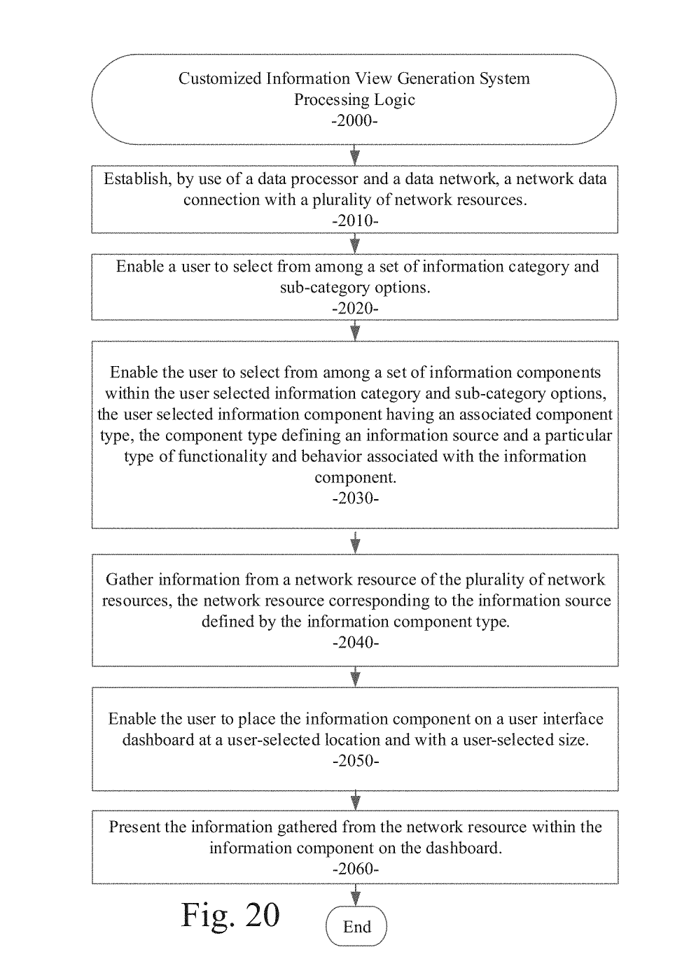

Referring now to FIG. 20, a processing flow diagram illustrates an example embodiment of a method implemented by the customized information view generation system 200 as described herein. The method 2000 of an example embodiment includes: establishing, by use of a data processor and a data network, a network data connection with a plurality of network resources (processing block 2010); enabling a user to select from among a set of information category and sub-category options (processing block 2020); enabling the user to select from among a set of information components within the user selected information category and sub-category options, the user selected information component having an associated component type, the component type defining an information source and a particular type of functionality and behavior associated with the information component (processing block 2030); gathering information from a network resource of the plurality of network resources, the network resource corresponding to the information source defined by the information component type (processing block 2040); enabling the user to place the information component on a user interface dashboard at a user-selected location and with a user-selected size (processing block 2050); and presenting the information gathered from the network resource within the information component on the dashboard (processing block 2060).

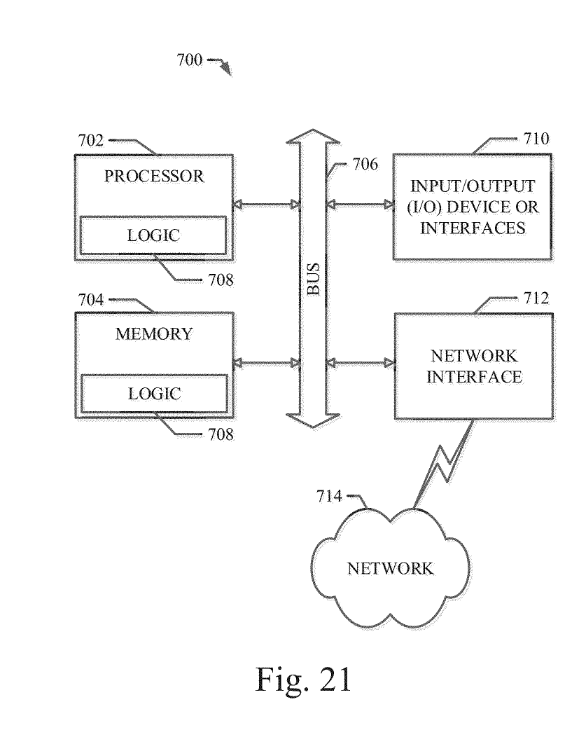

FIG. 21 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

As described herein for various example embodiments, a system and method for generating customized information views are disclosed. In various example embodiments, a software application program is used to enable the development and presentation of information categories, information sub-categories, and information components in customizable views on the display screen of a computing or communication system, including mobile devices. As described above, in a variety of contexts, the customized information view generation system 200 of an example embodiment can be configured to automatically obtain a variety of information from one or more 3rd party sites or network resources via a data network to facilitate the user experience of searching for desired information datasets, configuring a customized information view, and sharing a customized information view, all from the convenience of a computing device or a portable electronic device, such as a smartphone. This collection of particular user-selected information datasets and customized views has traditionally been possible only via multiple, personal interactions with a plurality of different parties at different locations. The embodiments as presently disclosed and claimed enable these disparate transactions to be integrated into a single set of electronic interactions with a mobile device or other computing device. As such, the various embodiments as described herein are necessarily rooted in computer and network technology and serve to improve these technologies when applied in the manner as presently claimed. In particular, the various embodiments described herein improve the use of computing device technology and mobile device technology in combination with data network technology in the context of customized information views via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
establishing, by use of a data processor and a data network, a network data connection with a plurality of network resources;
enabling a user to select from among a set of information category and sub-category options;
enabling the user to select from among a set of information components within the user selected information category and sub-category options, the user selected information component having an associated component type, the component type defining an information source and a particular type of functionality and behavior associated with the information component;
gathering information from a network resource of the plurality of network resources, the network resource corresponding to the information source defined by the information component type;
enabling the user to place the information component on a user interface dashboard at a user-selected location and with a user-selected size; and
presenting the information gathered from the network resource within the information component on the dashboard.

2. The method of claim 1 further including enabling the user to create a new information category or sub-category option.

3. The method of claim 1 further including enabling the user to create a new information component.

4. The method of claim 1 wherein the information component type is of a type from the group consisting of: an alert, a document library, an embedded feed, an embedded map, an external link, a global alert, a photo gallery, an RSS (Really Simple Syndication) feed, and a situation report.

5. The method of claim 1 further including enabling the user to create a view including a plurality of information components placed on the user interface dashboard at user-selected locations and with user-selected sizes.

6. The method of claim 5 further including enabling the user to save the view with a specified name.

7. The method of claim 5 further including enabling the user to create new view from a set of pre-configured view templates.

8. The method of claim 5 further including enabling the user to share a view with other users in a specified organization.

9. The method of claim 5 further including enabling the user to share a view with other users in a specified sharing group.

10. A system comprising:
a data processor;
a network interface, in data communication with the data processor, for communication on a data network; and
a customized information view generation system, executable by the data processor, to:
establish, by use of the data processor and the data network, a network data connection with a plurality of network resources;
enable a user to select from among a set of information category and sub-category options;
enable the user to select from among a set of information components within the user selected information category and sub-category options, the user selected information component having an associated component type, the component type defining an information source and a particular type of functionality and behavior associated with the information component;
gather information from a network resource of the plurality of network resources, the network resource corresponding to the information source defined by the information component type;
enable the user to place the information component on a user interface dashboard at a user-selected location and with a user-selected size; and
present the information gathered from the network resource within the information component on the dashboard.

11. The system of claim 10 being further configured to enable the user to create a new information category or sub-category option.

12. The system of claim 10 being further configured to enable the user to create a new information component.

13. The system of claim 10 wherein the information component type is of a type from the group consisting of: an alert, a document library, an embedded feed, an embedded map, an external link, a global alert, a photo gallery, an RSS (Really Simple Syndication) feed, and a situation report.

14. The system of claim 10 being further configured to enable the user to create a view including a plurality of information components placed on the user interface dashboard at user-selected locations and with user-selected sizes.

15. The system of claim 14 being further configured to enable the user to save the view with a specified name.

16. The system of claim 14 being further configured to enable the user to create new view from a set of pre-configured view templates.

17. The system of claim 14 being further configured to enable the user to share a view with other users in a specified organization.

18. The system of claim 14 being further configured to enable the user to share a view with other users in a specified sharing group.

19. A non-transitory machine-useable storage medium embodying instructions which, when executed by a machine, cause the machine to:
establish, by use of the data processor and the data network, a network data connection with a plurality of network resources;
enable a user to select from among a set of information category and sub-category options;
enable the user to select from among a set of information components within the user selected information category and sub-category options, the user selected information component having an associated component type, the component type defining an information source and a particular type of functionality and behavior associated with the information component;
gather information from a network resource of the plurality of network resources, the network resource corresponding to the information source defined by the information component type;
enable the user to place the information component on a user interface dashboard at a user-selected location and with a user-selected size; and
present the information gathered from the network resource within the information component on the dashboard.

20. The non-transitory machine-useable storage medium of claim 19 wherein the information component type is of a type from the group consisting of: an alert, a document library, an embedded feed, an embedded map, an external link, a global alert, a photo gallery, an RSS (Really Simple Syndication) feed, and a situation report.
